(19) United States
(12) Patent Application Publication
(10) Pub. No.: US 2007/0216922 A1
(43) Pub. Date: Sep. 20, 2007

(54) Printer

(75) Inventor: Shinichi Shikii, Kanagawa (JP)

Correspondence Address: SUGHRUE-265550, 2100 PENNSYLVANIA AVE. NW, WASHINGTON, DC, 20037-3213, US

(73) Assignee: FUJIFILM Corporation

(21) Appl. No.: 11/715,867

(22) Filed: Mar. 9, 2007

(30) Foreign Application Priority Data
Mar. 16, 2006 (JP) P2006-073172

(51) Int. Cl. G06F 15/00

(52) U.S. Cl. 358/1.9; 358/504

(57) ABSTRACT

A printer which outputs and records a test pattern onto a recording medium and evaluates quality of an image produced by the printer based on the test pattern recorded on the recording medium, wherein: the test pattern comprises: a pattern for visual evaluation; and a quality control pattern including an evaluation content description information field indicating information of contents of the visual evaluation and an information input field for adding information of an evaluation result of the visual evaluation.

### FIELD OF THE INVENTION

The present invention relates to a printer having a function to output and record a predetermined test pattern onto a recording medium and evaluate quality of a recorded image based on an output image of the test pattern.

### BACKGROUND OF THE INVENTION

Various diagnostic image acquisition systems using X-rays or the like have been heretofore used in the medical field. For example, X-ray machines, CR (Computed Radiography) machines, CT (Computed tomography) machines, MRI (Magnetic Resonance Imaging) machines, etc. have been put into practical use.

Medical image information acquired by these machines is developed on a recording medium such as a film by a printer and used for medical diagnosis. For such medical diagnosis based on an image, a monochrome (black and white) image is typically used, and a microscopic structure is observed through a difference of density in the image. It is therefore important to keep various conditions of the printer such as sharpness, contrast, distortion, etc. in an enough good level.

To this end, in a background-art medical printer for outputting a medical image such as an X-ray transparent image, various works for outputting a specific test pattern and verifying quality stability of the image have been proposed to secure a constant image quality (see JP-A-2004-122443). Of the verification works, some are items to be automatically measured by the printer itself, but there still remain other items to be visually evaluated by a user, such as recognition of a low density portion (contrast visibility), the number of recording pixels (resolution), etc.

### SUMMARY OF THE INVENTION

However, in terms of the visual evaluation items, it is necessary to prepare a manual 1 close at hand, and read and grasp the contents of evaluation works or the like from the manual 1 as shown in FIG. 6. Therefore, a worker such as a user or a service man having the manual 1 close at hand specifies necessary evaluation items 2, performs visual evaluation on an output result of a test pattern for each evaluation item 2 based on criteria 3, and fills the manual 1 (for example, determination field 4) with evaluation results.

In such a work of visual evaluation, the worker must prepare the manual 1 and make evaluation while reading the contents on the manual 1 one by one whenever the worker performs maintenance. The evaluation work is not user-friendly but troublesome.

The present invention was developed in consideration of the aforementioned situation. An object of the invention is to provide a printer having a quality control function in which the contents of criteria can be grasped efficiently, and smooth and user-friendly visual evaluation can be performed.

The aforementioned object of the invention is attained by the following configurations.
(1) A printer having a function to output and record a test pattern onto a recording medium and evaluate quality of an image produced by the printer based on an output image of the test pattern, wherein the test pattern includes a pattern for visual evaluation, and a quality control pattern including an evaluation content description information field for indicating information of execution contents of the visual evaluation and an information input field for adding information of an evaluation result of the visual evaluation is outputted to the recording medium together with the pattern for the visual evaluation.

According to the printer configured thus, the quality control pattern including the evaluation content description information field for indicating the information of the execution contents of visual evaluation, and the information input field for adding information of an evaluation result of the visual evaluation is outputted to one and the same recording medium together with the visual evaluation pattern. In the work of the visual evaluation, it is therefore unnecessary to prepare a manual and make evaluation while reading the evaluation contents on the manual one by one whenever maintenance is performed. Thus, the visual evaluation work can be performed easily, and the user-friendliness is improved greatly. In addition, a result of the evaluation can be written into the information input field. It is therefore possible to avoid the labor for opening the manual and writing the result on the manual each time, and it is possible to safekeep the result of the evaluation together on the recording medium to which the visual evaluation pattern is outputted.
(2) The printer according to the aforementioned paragraph (1), wherein the pattern for the visual evaluation includes an individual pattern relating to at least one quality of contrast, density and sharpness.

According to the printer configured thus, the visual evaluation pattern includes an individual pattern relating to at least one quality of contrast, density and sharpness. It is therefore possible to keep and manage the quality of an output image recorded on the recording medium in a required level. Thus, it is possible to keep the accuracy of image diagnosis high.
(3) The printer according to the aforementioned paragraph (2), wherein the evaluation content description information field of the quality control pattern includes a pattern which displays a reduced image of the pattern for the visual evaluation, and information of the execution contents described in accordance with the individual pattern.

According to the printer configured thus, the evaluation content description information field includes the pattern which displays a reduced image of the pattern for the visual evaluation, and the information of the execution contents described in accordance with the individual pattern. The execution contents for the individual pattern are easy to understand. It is therefore possible to easily understand the execution contents by a simple method of viewing the evaluation content description information field. Thus, an error in evaluation can be prevented.
(4) The printer according to any one of the aforementioned paragraphs (1) through (3), wherein the evaluation result is indicated in the information input field by notching a part of the recording medium after outputting of the respective patterns.

Accordingly to the printer configured thus, the evaluation result is indicated in the information input field by notching a part of the recording medium after outputting of each pattern. Thus, the evaluation result cannot be altered thereafter, but can be safekept as highly reliable data.
(5) The printer according to any one of the aforementioned paragraphs (1) through (4), having: a timing control unit for outputting the test pattern at timing when at least one of items including a use period (operating period) of the printer and a number of printouts from the printer reaches a predetermined value.

According to the printer configured thus, due to provision of the timing control unit for outputting the test pattern at timing when a use period of the printer, a number of printouts from the printer, or the like, reaches a predetermined value, the test pattern including necessary evaluation items can be outputted at the timing when evaluation is required. It is therefore possible to prevent the work of evaluation from being forgotten, and make the evaluation periodically and surely.
(6) The printer according to any one of the aforementioned paragraphs (1) through (5), wherein the printer is a medical printer for outputting a transparent monochrome film.

According to the printer configured thus, it is possible to obtain a medical printer for outputting a transparent monochrome film in which the contents of criteria can be grasped efficiently, and smooth and user-friendly visual evaluation can be performed.

According to the printer of the invention, it is possible to provide a printer having a quality control function in which the contents of criteria can be grasped efficiently, and smooth and user-friendly visual evaluation can be performed.

### BRIEF DESCRIPTION OF THE DRAWINGS

FIG. 1 is a block diagram showing a schematic configuration of an embodiment of a printer having a quality control function for an outputted image according to the invention.

FIG. 2 is a test pattern view where a visual evaluation pattern and a quality control pattern are displayed together.

FIG. 3 is a flow chart showing a control procedure of the printer.

FIG. 4 is another test pattern view where a visual evaluation pattern and a quality control pattern are displayed together.

FIG. 5 is a main portion plan view of a recording medium where a part thereof is notched to indicate an evaluation result.

FIG. 6 is a view showing a background-art manual.

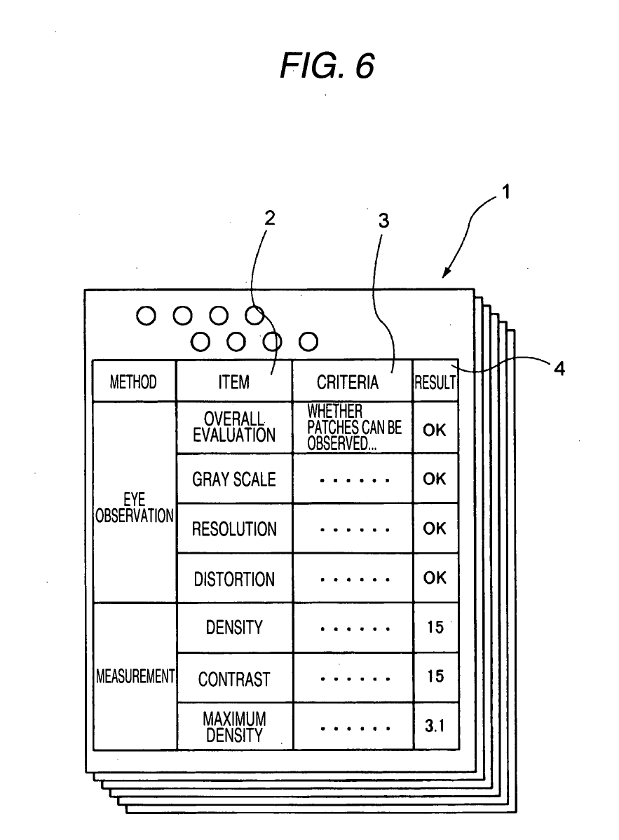

### DETAILED DESCRIPTION OF THE INVENTION

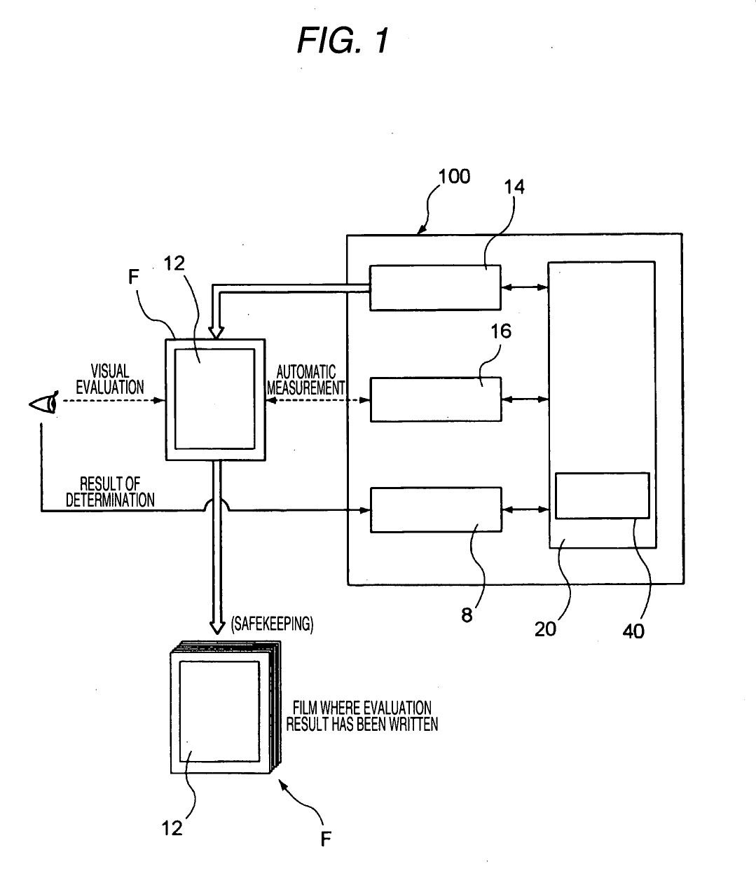

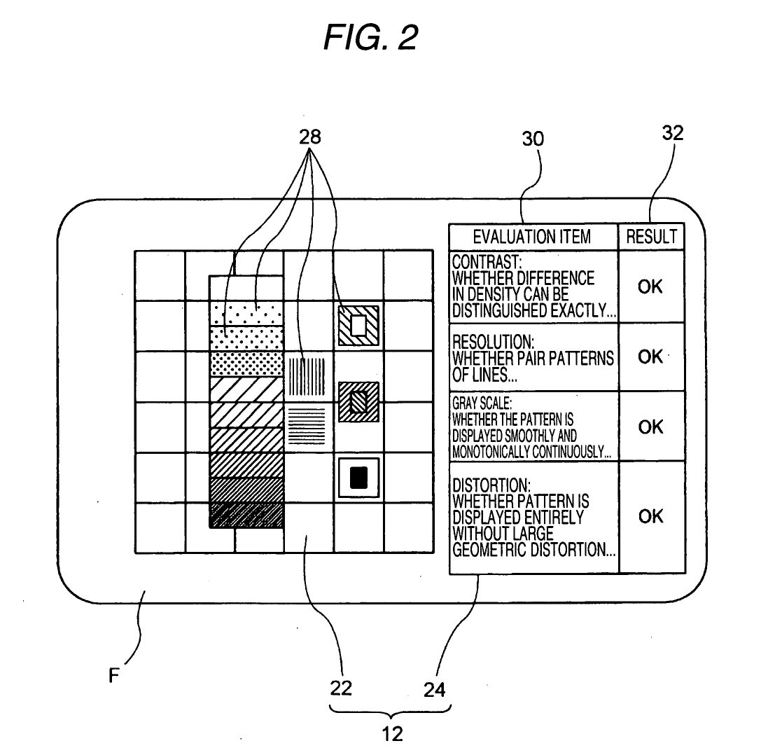

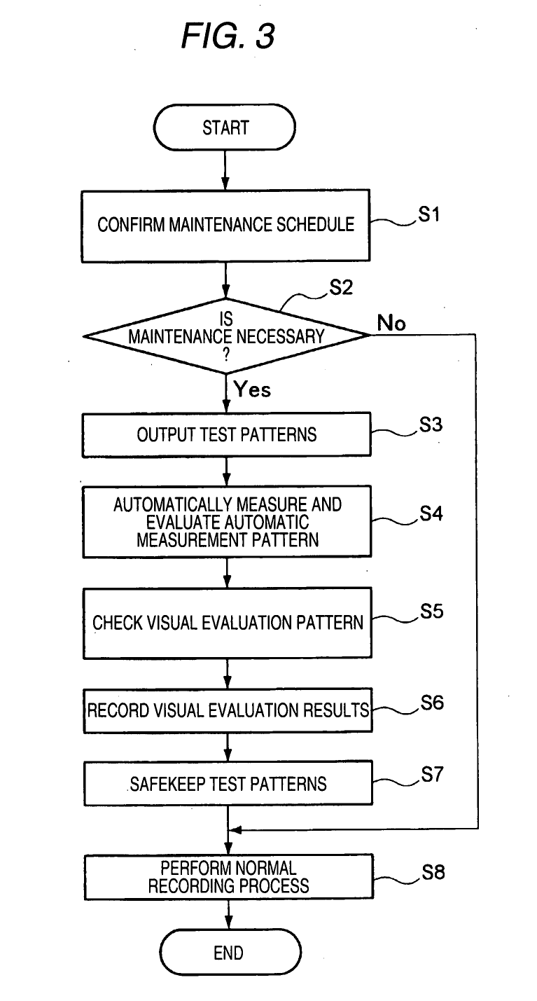

A preferred embodiment of a printer according to the present invention will be described below in detail with reference to the drawings. FIG. 1 is a block diagram showing a schematic configuration of an embodiment of a printer having a quality control function for an outputted image according to the invention. FIG. 2 is a test pattern view where a visual evaluation pattern and a quality control pattern are displayed simultaneously. FIG. 3 is a flow chart showing a control procedure of the printer.

As shown in FIG. 1, a printer 100 according to this embodiment thermally records an image on an optically transparent thermal recording film (referred to as “recording medium”) F having a predetermined size such as a half size. The printer 100 has an image output portion 14 for outputting a test pattern for automatic measurement or visual evaluation, a quality measuring portion 16 for automatically measuring the qualities of the outputted image, an input portion 8 for inputting results of visual evaluation or the like, and a control portion 20 for controlling the operations of these portions constituting the printer 100. The control portion 20 has a timing control unit 40 for making control to output a test pattern 12 at timing when the use period of the printer 100 or the number of outputted images reaches a predetermined value.

The printer 100 according to this embodiment is regarded as a medical printer for outputting a transparent monochrome film. However, the printer 100 is not limited thereto especially.

As a specific example of the recording medium, a heat developing photosensitive material or a photosensitive thermal recording material can be used. The heat developing photosensitive material is a recording material on which an image can be recorded (exposed) by a light beam (for example, laser beam) and then thermally developed for color development. The photosensitive thermal recording material is a recording material on which an image can be recorded by a light beam and then thermally developed for color development or on which an image can be recorded concurrently with color development by a laser beam or a heat mode (heat) of a thermal head and then fixed by irradiation with light.

Examples of qualities of the automatic measurement test pattern to be automatically measured include density, shading, etc. These qualities are automatically measured by the quantity measuring portion 16. When, for example, the test pattern is a density measurement pattern, a pattern for measurement of density at three points of high density, middle density and low density is used.

As shown in FIG. 2, in the visual evaluation test pattern 12, a visual evaluation pattern 22 and a quality control pattern 24 are arranged side by side and outputted to one and the same recording medium F. The visual evaluation pattern 22 is, for example, composed of a plurality of patterns 28 for testing contrast, resolution, gray scale, image distortion, etc. Each individual pattern 28 relates to at least one quality of contrast, density and sharpness.

A default pattern for visual evaluation or a practical clinical image such as chest or genucubital X-ray photogram can be used as the visual evaluation pattern 22. For example, a SMPET pattern is used for testing image distortion, spatial resolution, contrast, etc. A practical clinical image is used for checking whether there appear false contours or not, whether the image used as a diagnostic image will cause a problem or not, and so on.

The quality control pattern 24 has evaluation content description information fields 30 and information input fields 32. Information of execution contents of visual evaluation for the evaluation items (contrast, resolution, gray scale and image distortion in the embodiment shown in FIG. 2) is displayed in the evaluation content description information fields 30. Information of evaluation results of the visual evaluation is added in the information input fields 32.

By the timing control unit 40, the visual evaluation test pattern 12 is outputted at timing when the use period of the printer 100, the number of printouts from the printer 100, or the like, reaches a predetermined value set for each evaluation item.

The input portion 8 is provided for manually inputting the results of the visual evaluation given to the visual evaluation pattern 22 by a person. For example, a keyboard or the like is used as the input portion 8. When an automatic measurement test pattern is measured not by the quality measuring portion 16 such as a built-in densitometer but by a measuring unit outside the printer 100, values of the automatic measurement test pattern measured by the measuring unit outside the printer 100 are inputted from the input portion 8. Alternatively, the external measuring unit and the printer 100 may be connected to each other so that data can be inputted directly from the external measuring unit.

Next, the procedure for the printer 100 to output test patterns for maintenance (automatic measurement test pattern and visual evaluation test pattern) will be described with reference to FIG. 3.

First, when the printer 100 is powered ON, a maintenance schedule is confirmed in Step 1 (hereinafter referred to as “S1”).

Specifically, it is determined in S2 whether the use period of the printer 100, the number of printouts from the printer 100, or the like, reaches a predetermined value set for each evaluation item or not. When it is concluded that the value of any item does not reach the predetermined value, no test pattern is outputted, but a normal recording process is performed in S8. When the value reaches the predetermined value, test patterns for maintenance (automatic measurement test pattern and visual evaluation test pattern 12) are outputted from the image output portion 14 in S3.

The qualities of the automatic measurement test pattern (not shown) are automatically measured and evaluated by the quality measuring portion 16 in S4. When, for example, the quality measurement relates to density, the automatic measurement test pattern is a density measurement pattern composed of three density patterns of high density, middle density and low density. The density measurement pattern is measured by a built-in densitometer serving as the quality measuring portion 16. For example, data measured by the quality measuring portion 16 (for example, densitometer) are evaluated by comparison between proper values of data stored as the density measurement pattern in a memory in advance and measured values obtained by measuring the outputted density measurement pattern.

Next, the visual evaluation test pattern 12 is checked in S5. In the visual evaluation test pattern 12, a visual evaluation pattern 22 including individual patterns 28 each relating to at least one of qualities of contrast, density and sharpness and a quality control pattern 24 composed of evaluation content description information fields 30 and information input fields 32 are arranged side by side and displayed (see FIG. 2).

Here, the information of visual evaluation items to be evaluated and execution contents is displayed in detail in the evaluation content description information fields 30 of the quality control pattern 24. Accordingly, the worker does not have to prepare a manual or the like but can check the visual evaluation items efficiently by a simple method of viewing the visual evaluation test pattern 12.

As shown in FIG. 2, when, for example, the visual evaluation items are contrast, resolution, gray scale and image distortion, information about evaluation contents of these items is described in detail in the evaluation content description information fields 30 of the quality control pattern 24.

For example, there are written criteria of contrast such as “whether a difference in density can be exactly distinguished among patches in a plurality of stages of the visual evaluation pattern 22” and “whether a 5% patch and a 95% patch can be identified by eye observation”, and criteria of resolution such as “whether pair patterns of horizontal and vertical lines in a Nyquist rate can be identified in any position and any direction”, and so on.

In addition, there are written criteria of gray scale such as “whether the pattern is displayed smoothly and monotonically continuously”, and criteria of image distortion such as “whether the pattern is displayed entirely without large geometric distortion”, “whether the pattern is displayed with a proper aspect ratio, and whether each grid shows a square”, “whether each line is displayed straightly without curving or waving, and whether the line shows a proper linearity,” “whether “barreled distortion” or “pincushion distortion” is small enough not to be excessive but to be normal”, and so on.

The worker checks the visual evaluation pattern 22 in accordance with the aforementioned criteria written in the quality control pattern 24 (evaluation content description information fields 30). In S6, results of the visual evaluation are written into the information input fields 32 of the quality control pattern 24. A recording medium F where the results of the visual evaluation have been written is safekept in a cabinet or the like in S7. After that, a normal recording process is performed (S8).

While the results of the visual evaluation are written into the information input fields 32 of the quality control pattern 24, the results of the visual evaluation may be inputted into the control portion 20 through the input portion 8 such as a keyboard so as to be recorded as electronic data together with the test pattern. Thus, the image test results and so on are stored as quality control data.

In the printer 100, the image quality is checked periodically in order to keep the image quality in good condition. The period of the periodical check is defined for each evaluation item. Each of test patterns is automatically outputted based on a timing signal by a timing control unit 40 as soon as the use period of the printer 100, the number of image prints outputted from the printer 100, or the like, reaches a predetermined value set for each evaluation item.

The timing of evaluation differs from one evaluation item to another. For example, the timing is once per day, once per month, one per three months, once per year, or the like. Accordingly, it is likely that test patterns will be outputted in different times in such a manner that test patterns to be checked once per month are outputted today, and test patterns to be checked once per three months will be outputted tomorrow. In that case, the work of evaluation must be done on all such occasions. Thus, there is a fear that the work of evaluation becomes troublesome.

In order to avoid such troublesomeness, for example, it is desired that the day of the week when test patterns should be outputted is defined as a fixed date (for example, Monday) so that test patterns of a plurality of items to be outputted in different evaluation timings can be evaluated together. For example, assume that the day when test patterns should be outputted is Monday. In this case, test patterns to be outputted once per month are outputted once per 4 weeks, test patterns to be outputted once per 3 months are outputted once per 12 weeks, and test patterns to be outputted once per year are outputted once per 52 weeks. When the output days of the test patterns are changed thus, a plurality of evaluation items can be evaluated together on the same day conveniently.

In this event, it is desired that the set intervals of evaluation are set to be shorter than the normal intervals of evaluation in order to further improve the reliability of the evaluation. When the test patterns are outputted together in this manner and evaluated on the same day, it is possible to save the man-hour required for the evaluation, and it is also possible to make the operation easier and prevent the evaluation from being forgotten.

As for evaluation items whose evaluation timings should be defined by the number of printouts from the printer 100, their evaluation dates change in accordance with the frequency of use of the printer 100. It is difficult to estimate the evaluation dates. It is therefore desired that any evaluation item is evaluated in accordance with the number of outputted prints without changing its evaluation timing.

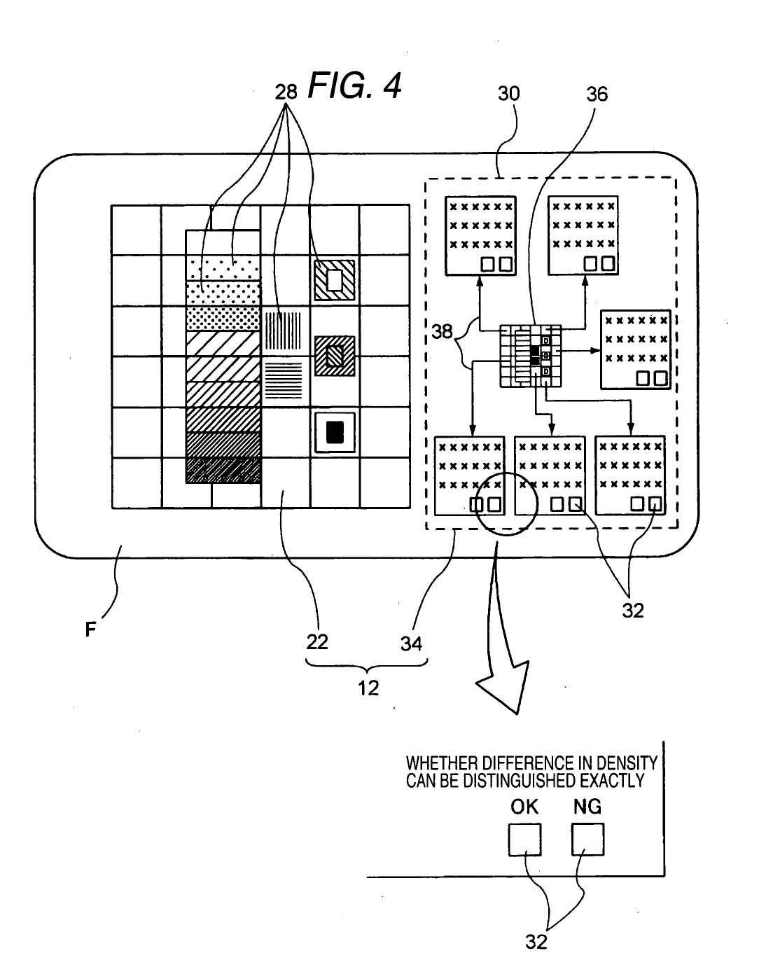

Next, another embodiment of display of a visual evaluation test pattern will be described with reference to FIG. 4. FIG. 4 is another test pattern view in which a visual evaluation pattern and a quality control pattern are displayed together. The visual evaluation test pattern in this embodiment is the same as that in FIG. 2, except that a method for displaying a quality control pattern is different from that of the quality control pattern 24 described in FIG. 2. Accordingly, parts the same as those in FIG. 2 are given the same or similar reference numerals correspondingly, and description thereof will be omitted or simplified.

As shown in FIG. 4, in a visual evaluation test pattern 12, a visual evaluation pattern 22 and a quality control pattern 34 are displayed together. In the quality control pattern 34, a reduced pattern 36 where the visual evaluation pattern 22 is scaled down is displayed in the center, and evaluation content description information fields 30 and information input fields 32 are disposed around the reduced pattern 36. Parts of the reduced pattern 36 corresponding to patterns 28 of the visual evaluation pattern 22 are displayed to be associated with the evaluation content description information fields 30 and the information input fields 32 through leader lines 38 respectively.

Thus, it can be viscerally grasped which pattern 28 should be used for evaluation described in each evaluation content description information field 30. It is therefore possible to perform the evaluation work surely and easily. A result of evaluation (OK or NG) is written into an information input field 32 associated with the pattern 28 through its corresponding leader line 38. Thus, an error in writing can be prevented.

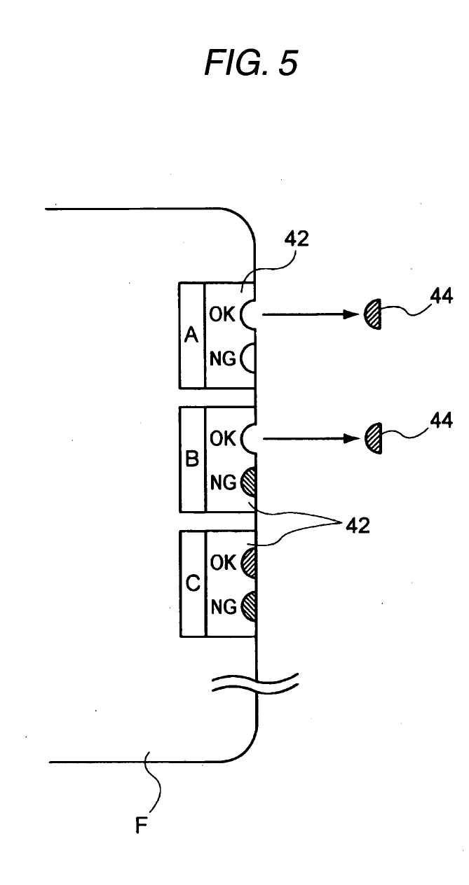

FIG. 5 is a main portion plan view of a recording medium showing a modification of the information input fields. A visual evaluation pattern in FIG. 5 is the same as the visual evaluation pattern described in FIG. 2 or FIG. 4, except for the information input fields. Therefore, the visual evaluation pattern is not illustrated in FIG. 5.

As shown in FIG. 5, an information input field 42 in the modification is provided for each evaluation item (depicted as A, B or C in FIG. 5). A portion of OK or NG in the information input field 42 of each evaluation item is punched in accordance with its evaluation result. That is, a portion 44 of a recording medium F is notched to indicate OK or NG of an evaluation result. In this manner, a portion 44 of the recording medium F is notched to indicate an evaluation result. Thus, the evaluation result cannot be altered. The reliability of stored data can be enhanced.

As described above, according to the printer 100 of the invention, the contents of criteria can be grasped efficiently so that smooth and user-friendly visual evaluation can be performed.

The printer according to the invention has been described above in detail. However, the invention is not limited to the aforementioned embodiments. Various improvements or changes can be made without departing from the gist of the invention.

This application is based on Japanese Patent application JP 2006-73172, filed Mar. 16, 2006, the entire content of which is hereby incorporated by reference, the same as if set forth at length.

What is claimed is:

1. A printer which outputs and records a test pattern onto a recording medium and evaluates quality of an image produced by the printer based on the test pattern recorded on the recording medium, wherein:
the test pattern comprises:
a pattern for visual evaluation; and
a quality control pattern including an evaluation content description information field indicating information of contents of the visual evaluation and an information input field for adding information of an evaluation result of the visual evaluation.

2. The printer according to claim 1, wherein the pattern for the visual evaluation includes an individual pattern relating to at least one quality of contrast, density and sharpness.

3. The printer according to claim 2, wherein the evaluation content description information field includes: a pattern which displays a reduced image of the pattern for the visual evaluation; and information of an evaluation content described in accordance with the individual pattern.

4. The printer according to claim 1, wherein the evaluation result is indicated in the information input field by notching a part of the recording medium after the test pattern is output.

5. The printer according to claim 2, wherein the evaluation result is indicated in the information input field by notching a part of the recording medium after the test pattern is output.

6. The printer according to claim 3, wherein the evaluation result is indicated in the information input field by notching a part of the recording medium after the test pattern is output.

7. The printer according to claim 1, which comprises:
a timing control unit which outputs the test pattern at timing when at least one of: an operating period of the printer; and a number of printouts from the printer reaches a value.

8. The printer according to claim 2, which comprises:
a timing control unit which outputs the test pattern at timing when at least one of: an operating period of the printer; and a number of printouts from the printer reaches a value.

9. The printer according to claim 3, which comprises:
a timing control unit which outputs the test pattern at timing when at least one of: an operating period of the printer; and a number of printouts from the printer reaches a value.

10. The printer according to claim 1, wherein the printer is a medical printer for outputting a transparent monochrome film.

11. The printer according to claim 2, wherein the printer is a medical printer for outputting a transparent monochrome film.

12. The printer according to claim 3, wherein the printer is a medical printer for outputting a transparent monochrome film.
